(19) United States
(12) Patent Application Publication
(10) Pub. No.: US 2021/0340913 A1
(43) Pub. Date: Nov. 4, 2021

(54) FUEL OXYGEN REDUCTION UNIT WITH BLEED DRIVEN BOOST IMPELLER

(71) Applicant: General Electric Company, Schenectady, NY (US)

(72) Inventors: Peter Allen Andrews, JR., Cincinnati, OH (US); Ethan Patrick O'Connor, Hamilton, OH (US); David Vickery Parker, Middleton, MA (US); Brandon Wayne Miller, Liberty Township, OH (US); Richard Alan Wesling, Cincinnati, OH (US); Christian Xavier Stevenson, Blanchester, OH (US)

(21) Appl. No.: 16/864,349

(22) Filed: May 1, 2020

(51) Int. Cl. F02C 7/22; F02C 3/00; C10G 29/00

(52) U.S. Cl. CPC F02C 7/22; C10G 29/00; F02C 3/00

(57) ABSTRACT

A fuel delivery system for a gas turbine engine including a fuel oxygen reduction unit is provided. The fuel oxygen reduction unit defines a liquid fuel flowpath and a stripping gas flowpath and is configured to transfer an oxygen content of a fuel flow through the liquid fuel flowpath to a stripping gas flow through the stripping gas flowpath. The fuel oxygen reduction unit includes an impeller in airflow communication with the stripping gas flowpath for circulating the stripping gas flow through the stripping gas flowpath; and a turbine coupled to the impeller.

### FIELD OF THE INVENTION

The present subject matter relates generally to a fuel oxygen reduction unit for an engine and a method of operating the same.

### BACKGROUND OF THE INVENTION

Typical aircraft propulsion systems include one or more gas turbine engines. The gas turbine engines generally include a turbomachine, the turbomachine including, in serial flow order, a compressor section, a combustion section, a turbine section, and an exhaust section. In operation, air is provided to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gasses through the turbine section drives the turbine section and is then routed through the exhaust section, e.g., to atmosphere.

Certain operations and systems of the gas turbine engines and aircraft may generate a relatively large amount of heat. Fuel has been determined to be an efficient heat sink to receive at least some of such heat during operations due at least in part to its heat capacity and an increased efficiency in combustion operations that may result from combusting higher temperature fuel.

However, heating the fuel up without properly conditioning the fuel may cause the fuel to “coke,” or form solid particles that may clog up certain components of the fuel system, such as the fuel nozzles. Reducing an amount of oxygen in the fuel may effectively reduce the likelihood that the fuel will coke beyond an unacceptable amount.

### BRIEF DESCRIPTION OF THE INVENTION

Aspects and advantages of the invention will be set forth in part in the following description, or may be obvious from the description, or may be learned through practice of the invention.

In one exemplary embodiment of the present disclosure, a fuel delivery system for a gas turbine engine is provided. The fuel delivery system includes a fuel oxygen reduction unit that defines a liquid fuel flowpath and a stripping gas flowpath and is configured to transfer an oxygen content of a fuel flow through the liquid fuel flowpath to a stripping gas flow through the stripping gas flowpath. The fuel oxygen reduction unit includes an impeller in airflow communication with the stripping gas flowpath for circulating the stripping gas flow through the stripping gas flowpath; and a turbine coupled to the impeller.

In certain exemplary embodiments the turbine is powered by a bleed air through a bleed air conduit, and wherein the stripping gas flowpath of the fuel oxygen reduction unit is in airflow communication with the bleed air conduit.

In certain exemplary embodiments the turbine is powered by a bleed air, and the impeller is coupled to, and driven by, the turbine.

In certain exemplary embodiments the turbine is powered by a main engine bleed air.

In certain exemplary embodiments the system includes a first valve downstream of the turbine, wherein the first valve modulates the main engine bleed air downstream of the turbine to control a speed of rotation of the impeller.

In certain exemplary embodiments the system includes a second valve upstream of the turbine, wherein the second valve modulates the main engine bleed air upstream of the turbine to control the speed of rotation of the impeller.

In certain exemplary embodiments the system includes a contactor including a fuel inlet that receives the fuel flow from the liquid fuel flowpath and a stripping gas inlet that receives the stripping gas flow from the stripping gas flowpath, the contactor configured to form a fuel/gas mixture; and a separator including an inlet in fluid communication with the contactor that receives the fuel/gas mixture, a fuel outlet, and a stripping gas outlet, wherein the separator is configured to separate the fuel/gas mixture into an outlet stripping gas flow and an outlet fuel flow and provide the outlet stripping gas flow through the stripping gas outlet back to the stripping gas flowpath and the outlet fuel flow through the fuel outlet back to the liquid fuel flowpath.

In certain exemplary embodiments the separator is coupled to a second power source that is separate from the turbine.

In certain exemplary embodiments the system includes a catalyst disposed downstream of the separator, the catalyst receives and treats the outlet stripping gas flow, wherein an inlet stripping gas flow exits the catalyst; wherein the impeller is disposed between the catalyst and the contactor.

In another exemplary embodiment of the present disclosure, a fuel delivery system for a gas turbine engine is provided. The fuel delivery system includes a fuel source; a draw pump downstream of the fuel source for generating a liquid fuel flow from the fuel source; a main fuel pump downstream of the draw pump; and a fuel oxygen reduction unit downstream of the draw pump and upstream of the main fuel pump. The fuel oxygen reduction unit includes a stripping gas line; a contactor in fluid communication with the stripping gas line and the draw pump for forming a fuel/gas mixture, wherein the contactor receives an inlet fuel flow from the draw pump; a separator in fluid communication with the contactor, the separator receives the fuel/gas mixture and separates the fuel/gas mixture into an outlet stripping gas flow and an outlet fuel flow at a location upstream of the main fuel pump; an impeller disposed downstream of the separator and upstream of the contactor, wherein the impeller circulates a stripping gas to the contactor; and a turbine coupled to the impeller.

In certain exemplary embodiments the turbine is powered by a bleed air, and the impeller is coupled to, and driven by, the turbine.

In certain exemplary embodiments the turbine is powered by a main engine bleed air.

In certain exemplary embodiments the system includes a first valve downstream of the turbine, wherein the first valve modulates the main engine bleed air downstream of the turbine to control a speed of rotation of the impeller.

In certain exemplary embodiments the system includes a second valve upstream of the turbine, wherein the second valve modulates the main engine bleed air upstream of the turbine to control the speed of rotation of the impeller.

In certain exemplary embodiments the separator is coupled to a second power source that is separate from the turbine.

In certain exemplary embodiments an input shaft of the separator is coupled to, and driven by, an accessory gearbox.

In certain exemplary embodiments the system includes a catalyst disposed downstream of the separator, the catalyst receives and treats the outlet stripping gas flow, wherein an inlet stripping gas flow exits the catalyst; wherein the impeller is disposed between the catalyst and the contactor.

In certain exemplary embodiments the turbine comprises a bleed gas recovery turbine.

In certain exemplary embodiments the main engine bleed air comprises a high pressure compressor bleed air, and wherein the fuel oxygen reduction unit recirculates the high pressure compressor bleed air back to a high pressure compressor of a main engine.

In certain exemplary embodiments the outlet fuel flow has a lower oxygen content than the inlet fuel flow, and wherein the outlet stripping gas flow has a higher oxygen content than the inlet stripping gas flow.

In an exemplary aspect of the present disclosure, a method is provided for operating a fuel delivery system for a gas turbine engine. The method includes receiving an inlet fuel flow in an oxygen transfer assembly of a fuel oxygen reduction unit for reducing an amount of oxygen in the inlet fuel flow using a stripping gas flow through a stripping gas flowpath; operating an impeller of the fuel oxygen reduction unit at a first speed; and operating a separator of the fuel oxygen reduction unit at a second speed that is different than the first speed.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic, cross-sectional view of a gas turbine engine in accordance with an exemplary embodiment of the present disclosure.

FIG. 2 is a schematic view of a fuel oxygen reduction unit in accordance with an exemplary embodiment of the present disclosure.

FIG. 3 is a schematic view of a fuel oxygen reduction unit in accordance with another exemplary embodiment of the present disclosure.

FIG. 4 is a schematic view of a fuel oxygen reduction unit in accordance with another exemplary embodiment of the present disclosure.

FIG. 5 is a schematic view of a fuel oxygen reduction unit in accordance with an exemplary embodiment of the present disclosure.

FIG. 6 is a schematic view of a fuel delivery system incorporating a fuel oxygen reduction unit in accordance with an exemplary embodiment of the present disclosure.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

In a fuel oxygen reduction unit of the present disclosure, an impeller is disposed downstream of a separator and upstream of a contactor. The impeller circulates a stripping gas to the contactor. Further, the impeller is coupled to, and driven by, a turbine. In an exemplary embodiment of the present disclosure, the turbine is powered by a bleed air from the engine. For example, the turbine is powered by a main engine bleed air. Advantageously, the system of the present disclosure allows for the impeller to be powered without being mechanically linked to an accessory gearbox of the engine. In this manner, the system of the present disclosure allows for control of a stripping gas flow rate independently of a speed of rotation of the main engine. This system allows for the impeller to be controlled and set at an optimum speed for the fuel oxygen reduction unit for a given cycle point of the engine. For example, the stripping gas flow rate and pressure needs to be precisely set for optimum efficiency. Using bleed air, e.g., compressor bleed air, as described herein to power the turbine allows for fine control and variation of a speed of rotation of the impeller with simple controls of a modulating valve/pressure regulator as described herein. The system of the present disclosure is a lightweight, high RPM solution without need for gear reduction and independent of the main engine.

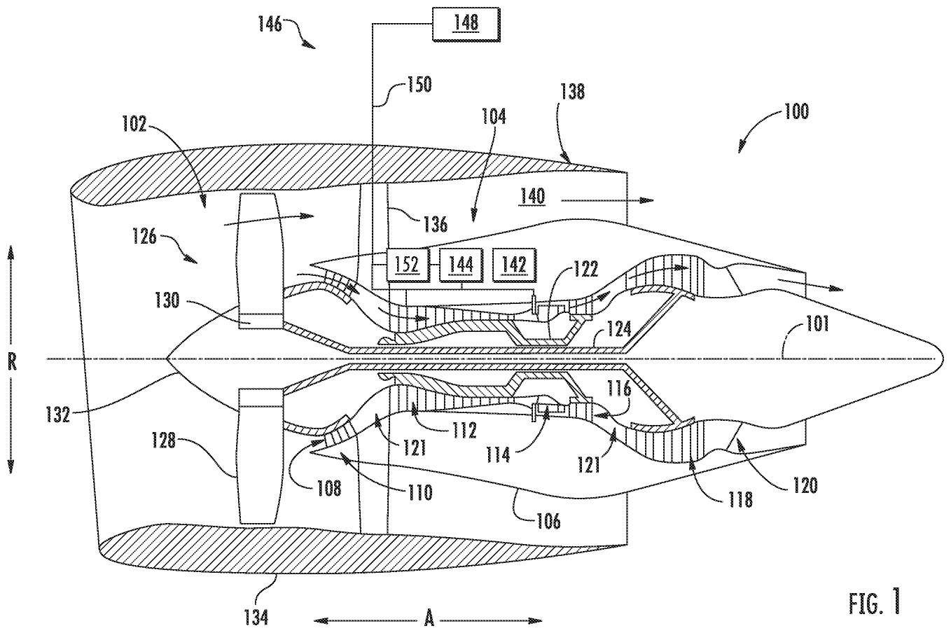

Referring now to the drawings, wherein identical numerals indicate the same elements throughout the figures, FIG. 1 provides a schematic, cross-sectional view of an engine in accordance with an exemplary embodiment of the present disclosure. The engine may be incorporated into a vehicle. For example, the engine may be an aeronautical engine incorporated into an aircraft. Alternatively, however, the engine may be any other suitable type of engine for any other suitable aircraft.

For the embodiment depicted, the engine is configured as a high bypass turbofan engine 100. As shown in FIG. 1, the turbofan engine 100 defines an axial direction A (extending parallel to a longitudinal centerline or axis 101 provided for reference), a radial direction R, and a circumferential direction (extending about the axial direction A; not depicted in FIG. 1). In general, the turbofan 100 includes a fan section 102 and a turbomachine 104 disposed downstream from the fan section 102.

The exemplary turbomachine 104 depicted generally includes a substantially tubular outer casing 106 that defines an annular inlet 108. The outer casing 106 encases, in serial flow relationship, a compressor section including a booster or low pressure (LP) compressor 110 and a high pressure (HP) compressor 112; a combustion section 114; a turbine section including a high pressure (HP) turbine 116 and a low pressure (LP) turbine 118; and a jet exhaust nozzle section 120. The compressor section, combustion section 114, and turbine section together define at least in part a core air flowpath 121 extending from the annular inlet 108 to the jet nozzle exhaust section 120. The turbofan engine further includes one or more drive shafts. More specifically, the turbofan engine includes a high pressure (HP) shaft or spool 122 drivingly connecting the HP turbine 116 to the HP compressor 112, and a low pressure (LP) shaft or spool 124 drivingly connecting the LP turbine 118 to the LP compressor 110.

For the embodiment depicted, the fan section 102 includes a fan 126 having a plurality of fan blades 128 coupled to a disk 130 in a spaced apart manner. The fan blades 128 and disk 130 are together rotatable about the longitudinal axis 101 by the LP shaft 124. The disk 130 is covered by rotatable front hub 132 aerodynamically contoured to promote an airflow through the plurality of fan blades 128. Further, an annular fan casing or outer nacelle 134 is provided, circumferentially surrounding the fan 126 and/or at least a portion of the turbomachine 104. The nacelle 134 is supported relative to the turbomachine 104 by a plurality of circumferentially-spaced outlet guide vanes 136. A downstream section 138 of the nacelle 134 extends over an outer portion of the turbomachine 104 so as to define a bypass airflow passage 140 therebetween.

Referring still to FIG. 1, the turbofan engine 100 additionally includes an accessory gearbox 142, a fuel oxygen reduction unit 144, and a fuel delivery system 146. For the embodiment shown, the accessory gearbox 142 is located within the cowling/outer casing 106 of the turbomachine 104. Additionally, it will be appreciated that, although not depicted schematically in FIG. 1, the accessory gearbox 142 may be mechanically coupled to, and rotatable with, one or more shafts or spools of the turbomachine 104. For example, in at least certain exemplary embodiments, the accessory gearbox 142 may be mechanically coupled to, and rotatable with, the HP shaft 122.

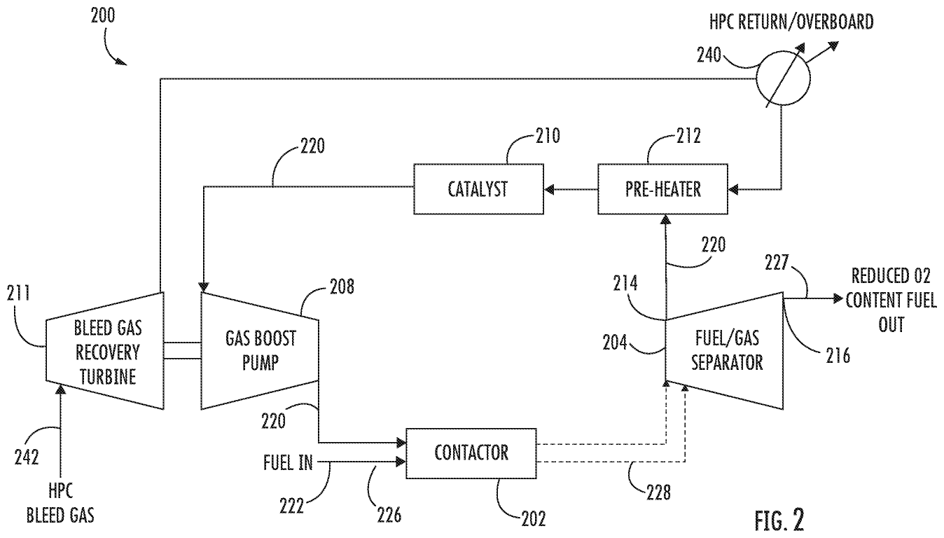

In an exemplary embodiment of the present disclosure, a component, e.g., an impeller 208 (FIG. 2), of the fuel oxygen reduction unit 144 is coupled to, or otherwise rotatable with, a turbine 152. In such a manner, it will be appreciated that a component, e.g., an impeller 208 (FIG. 2), of the exemplary fuel oxygen reduction unit 144 is driven by a turbine 152. Notably, as used herein, the term “fuel oxygen conversion or reduction” generally means a device capable of reducing a free oxygen content of the fuel. In the present disclosure, as described in more detail below with reference to FIG. 2, a power source for the impeller 208, i.e., a turbine 152, is different and separate then a power source for a separator 204. For example, the separator 204 is coupled to a second power source that is separate from the turbine 152. In an exemplary embodiment, an input shaft 232 (FIG. 2) of the separator 204 is coupled to, and driven by, an accessory gearbox 142. In other exemplary embodiments, the input shaft 232 (FIG. 2) may be mechanically coupled to any other suitable power source, such as an electric, hydraulic, pneumatic, or other power source that is separate from the turbine 211.

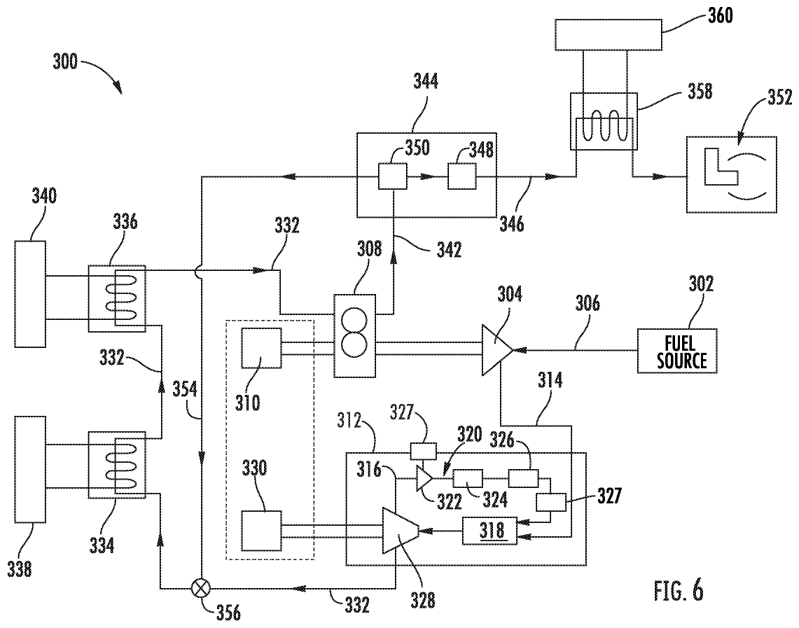

Moreover, the fuel delivery system 146 generally includes a fuel source 148, such as a fuel tank, and one or more fuel lines 150. The one or more fuel lines 150 provide a fuel flow through the fuel delivery system 146 to the combustion section 114 of the turbomachine 104 of the turbofan engine 100. A more detailed schematic of a fuel delivery system in accordance with an exemplary embodiment of the present disclosure is provided below with reference to FIG. 6.

It will be appreciated, however, that the exemplary turbofan engine 100 depicted in FIG. 1 is provided by way of example only. In other exemplary embodiments, any other suitable engine may be utilized with aspects of the present disclosure. For example, in other embodiments, the engine may be any other suitable gas turbine engine, such as a turboshaft engine, turboprop engine, turbojet engine, etc. In such a manner, it will further be appreciated that in other embodiments the gas turbine engine may have any other suitable configuration, such as any other suitable number or arrangement of shafts, compressors, turbines, fans, etc. Further, although the exemplary gas turbine engine depicted in FIG. 1 is shown schematically as a direct drive, fixed-pitch turbofan engine 100, in other embodiments, a gas turbine engine of the present disclosure may be a geared gas turbine engine (i.e., including a gearbox between the fan 126 and shaft driving the fan, such as the LP shaft 124), may be a variable pitch gas turbine engine (i.e., including a fan 126 having a plurality of fan blades 128 rotatable about their respective pitch axes), etc. Further, although not depicted herein, in other embodiments the gas turbine engine may be any other suitable type of gas turbine engine, such as an industrial gas turbine engine incorporated into a power generation system, a nautical gas turbine engine, etc. Further, still, in alternative embodiments, aspects of the present disclosure may be incorporated into, or otherwise utilized with, any other type of engine, such as reciprocating engines.

Moreover, it will be appreciated that although for the embodiment depicted, the turbofan engine 100 includes the fuel oxygen reduction unit 144 positioned within the turbomachine 104, i.e., within the casing 106 of the turbomachine 104, in other embodiments, the fuel oxygen reduction unit 144 may be positioned at any other suitable location. For example, in other embodiments, the fuel oxygen reduction unit 144 may instead be positioned remote from the turbofan engine 100. Additionally, in other embodiments, the fuel oxygen reduction unit 144 may additionally or alternatively be driven by other suitable power sources such as an electric motor, a hydraulic motor, or an independent mechanical coupling to the HP or LP shaft, etc.

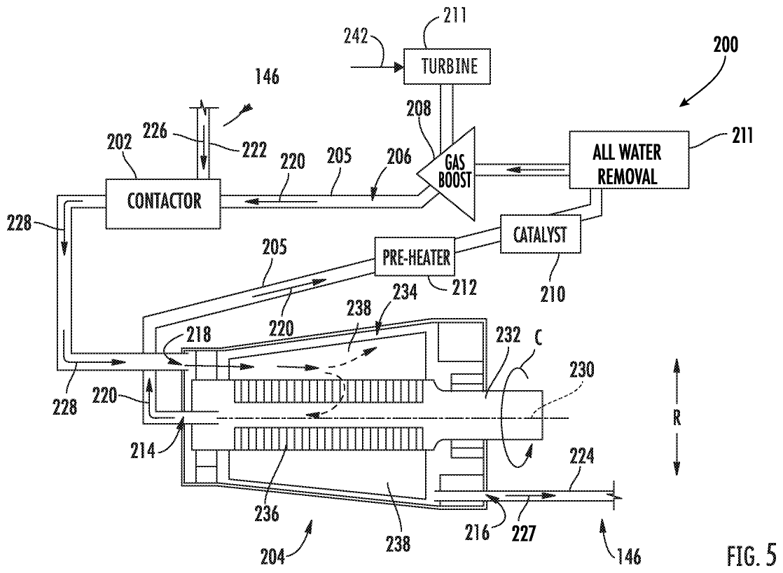

Referring now to FIGS. 2 and 5, schematic drawings of a fuel oxygen reduction unit or oxygen transfer assembly 200 for a gas turbine engine in accordance with an exemplary aspect of the present disclosure is provided. In at least certain exemplary embodiments, the exemplary fuel oxygen reduction unit 200 depicted may be incorporated into, e.g., the exemplary engine 100 described above with reference to FIG. 1 (e.g., may be the fuel oxygen reduction unit 144 depicted in FIG. 1 and described above).

As will be appreciated from the discussion herein, in an exemplary embodiment, the fuel oxygen reduction unit 200 generally includes a contactor 202, a separator 204, an impeller 208, and a turbine 211 that is coupled to the impeller 208. In one exemplary embodiment, the separator 204 may be a dual separator pump as described in more detail below and as shown in FIG. 5. In other exemplary embodiments, other separators may be utilized with the fuel oxygen reduction unit 200 of the present disclosure. In other exemplary embodiments, the oxygen transfer assembly 200 may include a membrane meant to filter or suck out the oxygen from the fuel into the stripping gas, or chemically react with the oxygen in the fuel to reduce the oxygen in the fuel. In such embodiments, the oxygen transfer assembly 200 may not include a contactor and a separator.

In fuel oxygen reduction unit 200 of the present disclosure, the impeller 208 is disposed downstream of the separator 204 and upstream of the contactor 202. The impeller 208 circulates a stripping gas 220 to the contactor 202. Further, the impeller 208 is coupled to, and driven by, a turbine 211. In an exemplary embodiment, the turbine 211 is powered by a bleed air from the engine. For example, the turbine 211 is powered by a main engine bleed air. In an exemplary embodiment, the turbine 211 is powered by a bleed air through a bleed air conduit, and the stripping gas flowpath of the fuel oxygen reduction unit 200 is in airflow communication with the bleed air conduit.

Advantageously, the system of the present disclosure allows for the impeller 208 to be powered without being mechanically linked to an accessory gearbox 142 of the engine. In this manner, the system of the present disclosure allows for control of a stripping gas flow rate independently of a speed of rotation of the main engine. This system allows for the impeller 208 to be controlled and set at an optimum speed for the fuel oxygen reduction unit 200 for a given cycle point of the engine. For example, the stripping gas flow rate and pressure needs to be precisely set for optimum efficiency. Using bleed air, e.g., compressor bleed air, as described herein to power the turbine 211 allows for fine control and variation of a speed of rotation of the impeller 208 with simple controls of a modulating valve/pressure regulator as described herein. The system of the present disclosure is a lightweight, high RPM solution without need for gear reduction and independent of the main engine.

In an exemplary embodiment, the turbine comprises a bleed gas recovery turbine. In an exemplary embodiment, the main engine bleed air comprises a high pressure compressor bleed air. In one embodiment, the fuel oxygen reduction unit recirculates the high pressure compressor bleed air back to a high pressure compressor of a main engine.

The exemplary contactor 202 depicted may be configured in any suitable manner to substantially mix a received gas and liquid flow, as will be described below. For example, the contactor 202 may, in certain embodiments be a mechanically driven contactor (e.g., having paddles for mixing the received flows), or alternatively may be a passive contactor for mixing the received flows using, at least in part, a pressure and/or flowrate of the received flows. For example, a passive contactor may include one or more turbulators, a venturi mixer, etc.

Moreover, the exemplary fuel oxygen reduction unit 200 includes a stripping gas line 205, and more particularly, includes a plurality of stripping gas lines 205, which together at least in part define a circulation gas flowpath 206 extending from the separator 204 to the contactor 202. In certain exemplary embodiments, the circulation gas flowpath 206 may be formed of any combination of one or more conduits, tubes, pipes, etc. in addition to the plurality stripping gas lines 205 and structures or components within the circulation gas flowpath 206.

As will be explained in greater detail, below, the fuel oxygen reduction unit 200 generally provides for a flow of stripping gas 220 through the plurality of stripping gas lines 205 and stripping gas flowpath 206 during operation. It will be appreciated that the term “stripping gas” is used herein as a term of convenience to refer to a gas generally capable of performing the functions described herein. The stripping gas 220 flowing through the stripping gas flowpath/circulation gas flowpath 206 may be an actual stripping gas functioning to strip oxygen from the fuel within the contactor, or alternatively may be a sparging gas bubbled through a liquid fuel to reduce an oxygen content of such fuel. For example, as will be discussed in greater detail below, the stripping gas 220 may be an inert gas, such as Nitrogen or Carbon Dioxide (CO2), a gas mixture made up of at least 50% by mass inert gas, or some other gas or gas mixture having a relatively low oxygen content.

Moreover, for the exemplary oxygen reduction unit depicted, the fuel oxygen reduction unit 200 further includes an impeller 208, a catalyst 210, a bleed gas power source 211, and a pre-heater 212. The impeller 208, the catalyst 210, and the pre-heater 212 may be arranged in different configurations within the circulation gas flowpath 206.

Referring to FIG. 2, in an exemplary embodiment, the arrangement includes the pre-heater 212, the catalyst 210, and the impeller 208 in a series flow. Thus, a flow of the stripping gas 220 exits a stripping gas outlet 214 of the separator 204 and then flows through the pre-heater 212, the catalyst, and the impeller 208 in a series flow. Next, the resulting relatively low oxygen content stripping gas is then provided through the remainder of the circulation gas flowpath 206 and back to the contactor 202, such that the cycle may be repeated.

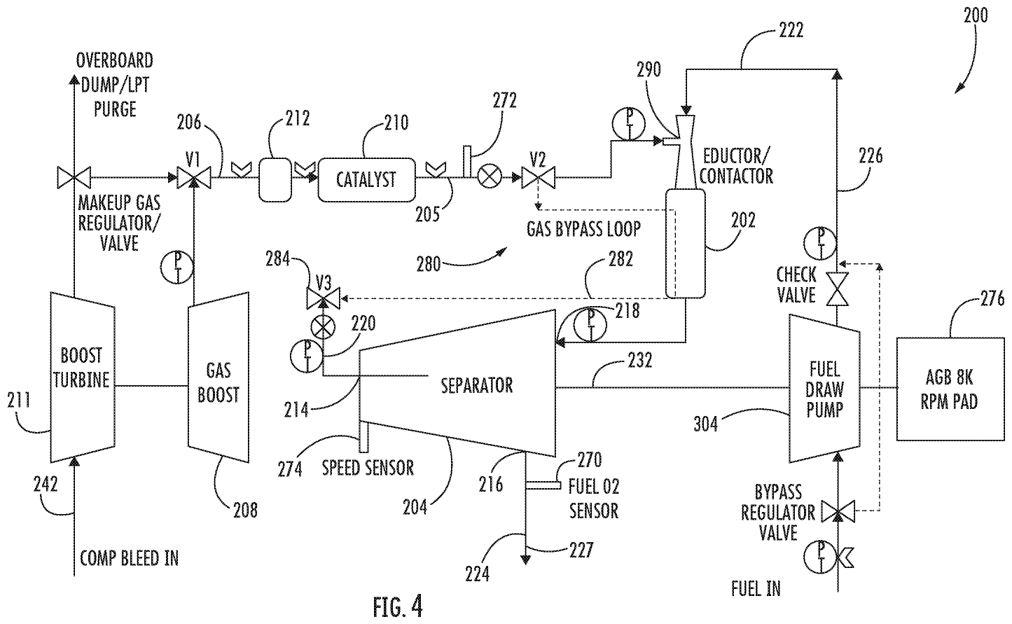

Referring to FIG. 4, in another exemplary embodiment, the arrangement includes the impeller 208, the pre-heater 212, and the catalyst 210 in a series flow. Thus, a flow of the stripping gas 220 exits a stripping gas outlet 214 of the separator 204 and then flows through the impeller 208, the pre-heater 212, and the catalyst 210 in a series flow. Next, the resulting relatively low oxygen content stripping gas is then provided through the remainder of the circulation gas flowpath 206 and back to the contactor 202, such that the cycle may be repeated.

In other exemplary embodiments, the arrangement of the components of the fuel oxygen reduction unit 200 may be arranged in different configurations within the circulation gas flowpath 206.

In an exemplary embodiment, the impeller 208 comprises a gas boost pump which increases a pressure of the stripping gas 220 flowing to the contactor 202. The gas boost pump 208 may be configured as a rotary gas pump coupled to, and driven by, a turbine 211 as shown in FIGS. 2-5.

In the present disclosure, in an exemplary embodiment, the power source for the impeller 208, i.e., the turbine 211, is different and separate then the power source for the separator 204. For example, the separator 204 is coupled to a second power source 260 that is separate from the turbine 211. In an exemplary embodiment, an input shaft 232 of the separator 204 is coupled to, and driven by, an accessory gearbox 142. In other exemplary embodiments, the input shaft 232 may be mechanically coupled to any other suitable power source, such as an electric, hydraulic, pneumatic, or other power source that is separate from the turbine 211. In yet another exemplary embodiment, the power source for the separator 204 may be the turbine 211. In another exemplary embodiment, the power source for the separator 204 and/or gas boost pump 208 may be another suitable electrical power source, such as a permanent magnet alternator (PMA) that may also serve to provide power to a full authority digital control engine controller (FADEC).

In an exemplary embodiment using a permanent magnet alternator (PMA) as a power source for a gas boost pump 208 and/or separator 204, a full authority digital control engine controller (FADEC) is powered by a dedicated PMA, which is in turn rotated by/driven by an accessory gearbox of a gas turbine engine. The PMA is therefore sized to be capable of providing a sufficient amount of electrical power to the FADEC during substantially all operating conditions, including relatively low-speed operating conditions, such as start-up and idle. As the engine comes up to speed, however, the PMA may generate an increased amount electric power, while an amount of electric power required to operate the FADEC may remain relatively constant. Accordingly, as the engine comes up to speed the PMA may generate an amount of excess electric power that may need to be dissipated through an electrical sink.

The inventors of the present disclosure have found that a power consumption need for a fuel oxygen reduction unit may complement the power generation of the PMA. More specifically, the fuel oxygen reduction unit may need a relatively low amount of electric power during low rotational speeds of the gas turbine engine (when the PMA is not creating much excess electrical power), and a relatively high amount of electric power during high rotational speeds of the gas turbine engine (when the PMA is creating excess electrical power). Accordingly, by using the PMA to power the fuel oxygen reduction unit, the electrical power generated by the PMA may be more efficiently utilized.

It will be appreciated, however, that such a configuration is by way of example only, and in other embodiments the FADEC may be any other suitable engine controller, the PMA may be any other suitable electric machine, etc. Accordingly, in certain embodiments, an engine system is provided for an aircraft having an engine and an engine controller. The engine system includes an electric machine configured to be in electrical communication with the engine controller for powering the engine controller; and a fuel oxygen reduction unit defining a liquid fuel flowpath and a stripping gas flowpath and configured to transfer an oxygen content of a fuel flow through the liquid fuel flowpath to a stripping gas flow through the stripping gas flowpath, the fuel oxygen reduction unit also in electrical communication with the electric machine such that the electric machine powers at least in part the fuel oxygen reduction unit.

Referring to FIG. 5, in an exemplary embodiment, the separator 204 generally includes a stripping gas outlet 214, a fuel outlet 216, and an inlet 218. It will also be appreciated that the exemplary fuel oxygen reduction unit 200 depicted is operable with a fuel delivery system 146, such as a fuel delivery system 146 of the gas turbine engine including the fuel oxygen reduction unit 200 (see, e.g., FIG. 1). The exemplary fuel delivery system 146 generally includes a plurality of fuel lines, and in particular, an inlet fuel line 222 and an outlet fuel line 224. The inlet fuel line 222 is fluidly connected to the contactor 202 for providing a flow of liquid fuel or inlet fuel flow 226 to the contactor 202 (e.g., from a fuel source, such as a fuel tank) and the outlet fuel line 224 is fluidly connected to the fuel outlet 216 of the dual separator pump 204 for receiving a flow of deoxygenated liquid fuel or outlet fuel flow 227.

Moreover, during typical operations, a flow of stripping gas 220 flows through the circulation gas flowpath 206 from the stripping gas outlet 214 of the separator 204 to the contactor 202. More specifically, during typical operations, stripping gas 220 flows from the stripping gas outlet 214 of the separator 204, through the pre-heater 212 (configured to add heat energy to the gas flowing therethrough), through the catalyst 210, and to/through the impeller 208, wherein a pressure of the stripping gas 220 is increased to provide for the flow of the stripping gas 220 through the circulation gas flowpath 206. The relatively high pressure stripping gas 220 (i.e., relative to a pressure upstream of the impeller 208 and the fuel entering the contactor 202) is then provided to the contactor 202, wherein the stripping gas 220 is mixed with the flow of inlet fuel 226 from the inlet fuel line 222 to generate a fuel gas mixture 228. The fuel gas mixture 228 generated within the contactor 202 is provided to the inlet 218 of the separator 204.

Referring to FIG. 2, in an exemplary embodiment, the catalyst 210 is disposed downstream of the separator 204. The catalyst 210 receives and treats the outlet stripping gas flow that flows out of the separator 204 to reduce the oxygen content of the outlet stripping gas flow. In this manner, an inlet stripping gas flow exits the catalyst and flows to the contactor 202. This inlet stripping gas flow that's flows to the contactor 202 has a lower oxygen content than the outlet stripping gas flow that flows out of the separator 204. Referring to FIG. 2, in an exemplary embodiment, the impeller 208 is disposed between the catalyst 210 and the contactor 202.

Generally, it will be appreciated that during operation of the fuel oxygen reduction unit 200, the inlet fuel 226 provided through the inlet fuel line 222 to the contactor 202 may have a relatively high oxygen content. The stripping gas 220 provided to the contactor 202 may have a relatively low oxygen content or other specific chemical structure. Within the contactor 202, the inlet fuel 226 is mixed with the stripping gas 220, resulting in the fuel gas mixture 228. As a result of such mixing a physical exchange may occur whereby at least a portion of the oxygen within the inlet fuel 226 is transferred to the stripping gas 220, such that the fuel component of the mixture 228 has a relatively low oxygen content (as compared to the inlet fuel 226 provided through inlet fuel line 222) and the stripping gas component of the mixture 228 has a relatively high oxygen content (as compared to the inlet stripping gas 220 provided through the circulation gas flowpath 206 to the contactor 202).

Within the separator 204 the relatively high oxygen content stripping gas 220 is then separated from the relatively low oxygen content fuel 226 back into respective flows of an outlet stripping gas 220 and outlet fuel 227.

In one exemplary embodiment, the separator 204 may be a dual separator pump as shown in FIG. 5. For example, the dual separator pump 204 defines a central axis 230, radial direction R, and a circumferential direction C extending about the central axis 230. Additionally, the dual separator pump 204 is configured as a mechanically-driven dual separator pump, or more specifically as a rotary/centrifugal dual separator pump. Accordingly, the dual separator pump 204 includes an input shaft 232 and a single-stage separator/pump assembly 234. The input shaft 232 is mechanically coupled to the single-stage separator/pump assembly 234, and the two components are together rotatable about the central axis 230. Further, the input shaft 232 may be mechanically coupled to, and driven by, e.g., an accessory gearbox (such as the exemplary accessory gearbox 142 of FIG. 1). However, in other embodiments, the input shaft 232 may be mechanically coupled to any other suitable power source, such as an electric, hydraulic, pneumatic, or other power source. As will be appreciated, the single-stage separator/pump assembly 234 may simultaneously separate the mixture 228 into flows of an outlet stripping gas 220 and outlet fuel 227 from the mixture 228 and increase a pressure of the separated outlet fuel 227 (as will be discussed in greater detail below).

Additionally, the exemplary single-stage separator/pump assembly 234 depicted generally includes an inner gas filter 236 arranged along the central axis 230, and a plurality of paddles 238 positioned outward of the inner gas filter 236 along the radial direction R. During operation, a rotation of the single-stage separator/pump assembly 234 about the central axis 230, and more specifically, a rotation of the plurality of paddles 238 about the central axis 230 (i.e., in the circumferential direction C), may generally force heavier liquid fuel 226 outward along the radial direction R and lighter stripping gas 220 inward along the radial direction R through the inner gas filter 236. In such a manner, the outlet fuel 227 may exit through the fuel outlet 216 of the dual separator pump 204 and the outlet stripping gas 220 may exit through the gas outlet 214 of the dual separator pump 204, as is indicated.

Further, it will be appreciated that with such a configuration, the outlet fuel 227 exiting the dual separator pump 204 through the fuel outlet 216 may be at a higher pressure than the inlet fuel 226 provided through inlet fuel line 222, and further higher than the fuel/gas mixture 228 provided through the inlet 218. Such may be due at least in part to the centrifugal force exerted on such liquid fuel 226 and the rotation of the plurality of paddles 238. Additionally, it will be appreciated that for the embodiment depicted, the liquid fuel outlet 216 is positioned outward of the inlet 218 (i.e., the fuel gas mixture inlet) along the radial direction R. Such may also assist with the increasing of the pressure of the outlet fuel 227 provided through the fuel outlet 216 of the separator 204.

For example, it will be appreciated that with such an exemplary embodiment, the separator 204 of the fuel oxygen reduction unit 200 may generate a pressure rise in the fuel flow during operation. As used herein, the term “pressure rise” refers to a net pressure differential between a pressure of the flow of outlet fuel 227 provided to the fuel outlet 216 of the separator 204 (i.e., a “liquid fuel outlet pressure”) and a pressure of the inlet fuel 226 provided through the inlet fuel line 222 to the contactor 202. In at least certain exemplary embodiments, the pressure rise of the liquid fuel 226 may be at least about sixty (60) pounds per square inch (“psi”), such as at least about ninety (90) psi, such as at least about one hundred (100) psi, such as up to about seven hundred and fifty (750) psi. With such a configuration, it will be appreciated that in at least certain exemplary embodiments of the present disclosure, the liquid fuel outlet pressure may be at least about seventy (70) psi during operation. For example, in at least certain exemplary embodiments, the liquid fuel out of pressure may be at least about one hundred (100) psi during operation, such as at least about one hundred and twenty-five (125) psi during operation, such as up to about eight hundred (800) psi during operation. Additional details about these dual functions of the separator 204 will be discussed below with reference to FIG. 6.

Further, it will be appreciated that the outlet fuel 227 provided to the fuel outlet 216, having interacted with the stripping gas 220, may have a relatively low oxygen content, such that a relatively high amount of heat may be added thereto with a reduced risk of the fuel coking (i.e., chemically reacting to form solid particles which may clog up or otherwise damage components within the fuel flow path). For example, in at least certain exemplary aspects, the outlet fuel 227 provided to the fuel outlet 216 may have an oxygen content of less than about five (5) parts per million (“ppm”), such as less than about three (3) ppm, such as less than about two (2) ppm, such as less than about one (1) ppm, such as less than about 0.5 ppm.

Moreover, as will be appreciated, the exemplary fuel oxygen reduction unit 200 depicted recirculates and reuses the stripping gas 220 (i.e., the stripping gas 220 operates in a substantially closed loop). However, the stripping gas 220 exiting the separator 204, having interacted with the liquid fuel 226, has a relatively high oxygen content. Accordingly, in order to reuse the stripping gas 220, an oxygen content of the stripping gas 220 from the outlet 214 of the separator 204 needs to be reduced. For the embodiment depicted, and as noted above, the stripping gas 220 flows through the pre-heater 212, through the catalyst 210 where the oxygen content of the stripping gas 220 is reduced, and through the impeller 208 where a pressure of the stripping gas 220 is increased to provide for the flow of the stripping gas 220 through the circulation gas flowpath 206.

More specifically, within the catalyst 210 the relatively oxygen-rich stripping gas 220 is reacted to reduce the oxygen content thereof. It will be appreciated that catalyst 210 may be configured in any suitable manner to perform such functions. For example, in certain embodiments, the catalyst 210 may be configured to combust the relatively oxygen-rich stripping gas 220 to reduce an oxygen content thereof. However, in other embodiments, the catalyst 210 may additionally, or alternatively, include geometries of catalytic components through which the relatively oxygen-rich stripping gas 220 flows to reduce an oxygen content thereof. In one or more of these embodiments, the catalyst 210 may be configured to reduce an oxygen content of the stripping gas 220 to less than about five percent (5%) oxygen (O2) by mass, such less than about two (2) percent (3%) oxygen (O2) by mass, such less than about one percent (1%) oxygen (O2) by mass.

The resulting relatively low oxygen content gas is then provided through the remainder of the circulation gas flowpath 206 and back to the contactor 202, such that the cycle may be repeated. In such a manner, it will be appreciated that the stripping gas 220 may be any suitable gas capable of undergoing the chemical transitions described above. For example, the stripping gas may be air from, e.g., a core air flowpath of a gas turbine engine including the fuel oxygen reduction unit 200 (e.g., compressed air bled from an HP compressor 112; see FIG. 1).

However, in other embodiments, the stripping gas may instead be any other suitable gas, such as an inert gas, such as Nitrogen or Carbon Dioxide (CO2), a gas mixture made up of at least 50% by mass inert gas, or some other gas or gas mixture having a relatively low oxygen content.

It will be appreciated, however, that the exemplary fuel oxygen reduction unit 200 described above is provided by way of example only. In other embodiments, the fuel oxygen reduction unit 200 may be configured in any other suitable manner.

In other embodiments, the stripping gas 220 may not flow through a circulation gas flowpath 206, and instead the fuel oxygen reduction unit 200 may include an open loop stripping gas flowpath, with such flowpath in flow communication with a suitable stripping gas source, such as a bleed air source, and configured to dump such air to the atmosphere downstream of the fuel gas separator 204.

As described above, in the fuel oxygen reduction unit 200 of the present disclosure, the impeller 208 is coupled to, and driven by, a turbine 211. In an exemplary embodiment, the turbine 211 is powered by a bleed air from the engine. For example, the turbine 211 is powered by a main engine bleed air. Advantageously, the system of the present disclosure allows for the impeller 208 to be powered without being mechanically linked to an accessory gearbox 142 of the engine. In this manner, the system of the present disclosure allows for control of a stripping gas flow rate independently of a speed of rotation of the main engine. This system allows for the impeller 208 to be controlled and set at an optimum speed for the fuel oxygen reduction unit 200 for a given cycle point of the engine.

Referring to FIG. 2, in an exemplary embodiment, the fuel oxygen reduction unit 200 includes a first valve 240 downstream of the turbine 211. The first valve 240 modulates a bleed air 242, e.g., a main engine bleed air, downstream of the turbine 211 to control a speed of rotation of the impeller 208.

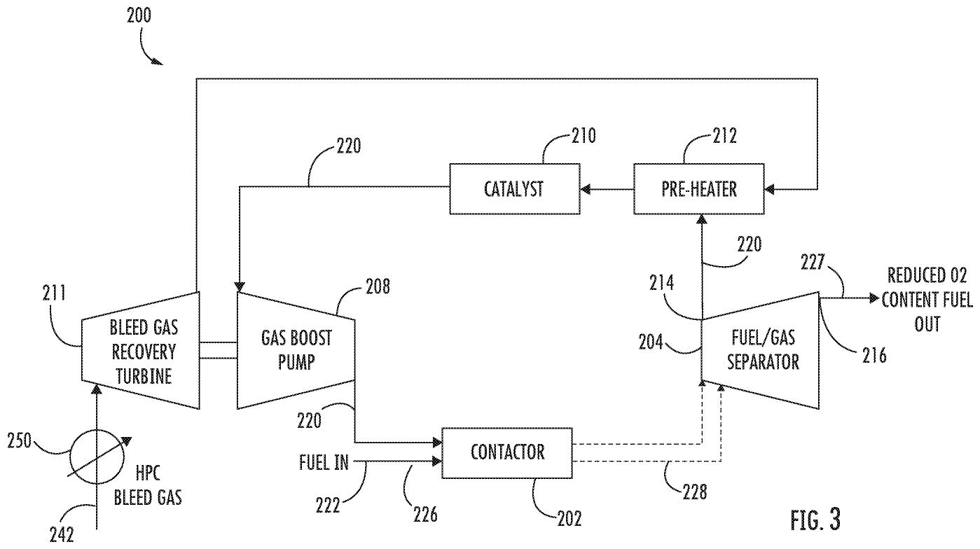

Referring to FIG. 3, in another exemplary embodiment, the fuel oxygen reduction unit 200 includes a second valve 250 upstream of the turbine 211. The second valve 250 modulates a bleed air 242, e.g., a main engine bleed air, upstream of the turbine 211 to control a speed of rotation of the impeller 208.

In another embodiment of the present disclosure, the fuel oxygen reduction unit 200 includes both a first valve 240 downstream of the turbine 211 and a second valve 250 upstream of the turbine 211. In this manner, the system has both the first valve 240 modulating a bleed air 242, e.g., a main engine bleed air, downstream of the turbine 211 to control a speed of rotation of the impeller 208 and the second valve 250 modulating a bleed air 242, e.g., a main engine bleed air, upstream of the turbine 211 to control the speed of rotation of the impeller 208.

Referring to FIG. 4, in another exemplary embodiment, the arrangement includes the impeller 208, the pre-heater 212, and the catalyst 210 in a series flow. Thus, a flow of the stripping gas 220 exits a stripping gas outlet 214 of the separator 204 and then flows through the impeller 208, the pre-heater 212, and the catalyst 210 in a series flow. Next, the resulting relatively low oxygen content stripping gas is then provided through the remainder of the circulation gas flowpath 206 and back to the contactor 202, such that the cycle may be repeated.

Referring to FIG. 4, in an exemplary embodiment, the fuel oxygen reduction unit 200 also includes a fuel oxygen sensor 270, a gas oxygen sensor 272, a speed sensor 274, and a gas bypass loop 280. The fuel oxygen sensor 270 is positioned at a portion of the outlet fuel line 224. The fuel oxygen sensor 270 is used to determine that an appropriate level of oxygen is present in the outlet fuel flow 227 and to determine that the outlet fuel flow 227 has had an appropriate level of oxygen removed from the inlet fuel flow 226. In other exemplary embodiments, the fuel oxygen sensor 270 can be positioned at other flow points in the system and/or additional fuel oxygen sensors 270 can also be utilized.

The gas oxygen sensor 272 is positioned at a portion of the stripping gas line 205. For example, the gas oxygen sensor 272 may be positioned at a portion of the stripping gas line 205 downstream of the catalyst 210. The gas oxygen sensor 272 is used to determine that an appropriate level of oxygen is present in the stripping gas flow 220 before entering the contactor 202 and to determine that the stripping gas exiting the pre-heater 212 and the catalyst 210 has had an appropriate level of oxygen removed from the stripping gas flow that exits the separator 204. In other exemplary embodiments, the gas oxygen sensor 272 can be positioned at other flow points in the system and/or additional gas oxygen sensors 272 can also be utilized.

The gas bypass loop 280 recirculates a pure stripping gas supply flow 282 to a flow of stripping gas 220 that exits the stripping gas outlet 214 of the separator 204. For example, the gas bypass loop 280 recirculates a pure stripping gas supply flow 282 to a flow of stripping gas 220 downstream of the stripping gas outlet 214 of the separator 204. Referring to FIG. 4, the gas bypass loop 280 extends from a location upstream of an inlet 290 of the contactor 202, prior to an inlet stripping gas flow entering the contactor 202 and being mixed with the inlet fuel flow 226 within the contactor 202, to a location downstream of the stripping gas outlet 214 of the separator 204. In this manner, a pure stripping gas supply flow 282 which has a reduced oxygen content after flowing through the pre-heater 212 and the catalyst 210, as described herein, is provided to a flow of stripping gas 220 that has a higher oxygen content that exits the stripping gas outlet 214 of the separator 204. Furthermore, a portion of the gas bypass loop 280 extends through the contactor 202 which acts as a heat exchanger for the bypass loop 280. Referring to FIG. 4, the gas bypass loop 280 includes a control valve 284 for controlling the mixing of a pure stripping gas supply flow 282 flowing through the gas bypass loop 280 to a flow of stripping gas 220 that exits the stripping gas outlet 214 of the separator 204.

Referring to FIG. 4, the power source for the impeller 208, i.e., the turbine 211, is different and separate then the power source for the shaft 232 of the separator 204. In an exemplary embodiment, an input shaft 232 of the separator 204 is coupled to, and driven by, an accessory gearbox 276. In other exemplary embodiments, the input shaft 232 may be mechanically coupled to any other suitable power source, such as an electric, hydraulic, pneumatic, or other power source that is separate from the turbine 211.

Referring now to FIG. 6, a schematic diagram is provided of a fuel delivery system 300 for a gas turbine engine in accordance with an exemplary embodiment of the present disclosure. In certain exemplary embodiments, the exemplary fuel delivery system 300 depicted in FIG. 6 may be utilized with the exemplary gas turbine engine described above with reference to FIG. 1 (i.e., configured as the exemplary fuel delivery system 146, operable with the exemplary turbofan engine 100), and/or may be configured as the exemplary fuel oxygen reduction unit 200 described above with reference to FIGS. 2 and 5. However, in other embodiments, the fuel delivery system 300 may be utilized with any other suitable gas turbine engine, vehicle (including, e.g., an aircraft), etc.

As is depicted, the fuel delivery system 300 generally includes a fuel source 302, a draw pump 304, and a first fuel line 306 extending between the fuel source 302 and the draw pump 304. The draw pump 304 may refer to the first pump located downstream of the fuel source 302 for generating a fuel flow from the fuel source 302. Accordingly, the draw pump 304 depicted is positioned downstream of the fuel source 302 for generating a flow of liquid fuel through the first fuel line 306 from the fuel source 302 (note that fuel flow directions through the fuel delivery system of FIG. 6 are indicated schematically as arrows on the respective fuel lines). When the exemplary fuel delivery system 300 is utilized with a gas turbine engine of an aircraft, the fuel source 302 may be a fuel tank, for example, a fuel tank positioned within one of the wings of the aircraft, within a fuselage of the aircraft, or any other suitable location.

The fuel delivery system 300 further includes, as will be discussed in greater detail below, a main fuel pump 308 positioned downstream of the draw pump 304. The main fuel pump 308 may refer to a fuel pump for providing pressurized fuel flow to the components for combusting such fuel (i.e., providing the last pressure rise upstream of such components combusting the fuel, as will be described in more detail below). For the embodiment depicted, the main fuel pump 308 is mechanically coupled to a first power source 310, and the draw pump 304 is mechanically coupled to and rotatable with the main fuel pump 308. In such a manner, the main fuel pump 308 and the draw pump 304 may share the first power source 310. For example, in certain embodiments, the first power source 310 may be a first pad of an accessory gearbox of the gas turbine engine (see, e.g. accessory gearbox 142 of FIG. 1). However, in other embodiments, the draw pump 304 may be powered by an independent power source relative to the main fuel pump 308. Further, in other embodiments, one or both of the draw pump 304 and main fuel pump 308 may be powered by any other suitable power source.

The exemplary fuel system of FIG. 6 further includes a fuel oxygen reduction unit 312 and a second fuel line 314. The fuel oxygen reduction unit 312 generally includes a stripping gas line 316 and a contactor 318. More specifically, the fuel oxygen reduction unit 312 defines a circulation gas flowpath 320, with the stripping gas line 316 defining at least in part the circulation gas flowpath 320. The contactor 318 is in fluid communication with the stripping gas line 316 (and circulation gas flowpath 320) and the draw pump 304 (through the second fuel line 314 for the embodiment shown) for forming a fuel/gas mixture. Notably, for the embodiment depicted, the exemplary fuel oxygen reduction unit 312 further includes an impeller 322, a pre-heater 324, a catalyst 326, and a turbine 327 coupled to the impeller 322. These components may be configured to provide the stripping gas through the circulation gas flowpath 320 and stripping gas line 316 with the desired properties to mix with the with fuel within the contactor 318 to reduce an oxygen content of the fuel.

As described above, in the fuel oxygen reduction unit 312 of the present disclosure, the impeller 322 is coupled to, and driven by, a turbine 327. In an exemplary embodiment, the turbine 327 is powered by a bleed air from the engine. For example, the turbine 327 is powered by a main engine bleed air. Advantageously, the system of the present disclosure allows for the impeller 322 to be powered without being mechanically linked to an accessory gearbox 142 of the engine. In this manner, the system of the present disclosure allows for control of a stripping gas flow rate independently of a speed of rotation of the main engine. This system allows for the impeller 322 to be controlled and set at an optimum speed for the fuel oxygen reduction unit 312 for a given cycle point of the engine.

Further, the exemplary fuel oxygen reduction unit 312 further includes a separator 328 in fluid communication with the contactor 318 for receiving the fuel/gas mixture from the contactor 318 and separating the fuel/gas mixture into an outlet stripping gas flow and an outlet fuel flow at a location upstream of the main fuel pump 308. Notably, the fuel oxygen reduction unit 312 and exemplary separator 328 of FIG. 6 may be configured in substantially the same manner as the exemplary fuel oxygen reduction unit 200 and separator 204 described above with reference to FIGS. 2 and 5. In such a manner, it will be appreciated that the separator 328 may be a mechanically-driven dual separator pump 328 coupled to a second power source 330. For the embodiment of FIG. 6, the second power source 330 may be a second pad of an accessory gearbox. In such a manner, the separator 328 and main fuel pump 308 (as well as the draw pump 304 for the embodiment shown) may each be driven by, e.g., an accessory gearbox. However, it will be appreciated, that for the embodiment depicted the main fuel pump 308 and separator 328 may be coupled to different pads of the accessory gearbox, such that they may be rotated at different rotational speeds.

In the present disclosure, the power source for the impeller 322, i.e., the turbine 327, is different and separate then the power source for the separator 328. For example, the separator 328 is coupled to a second power source 330 that is separate from the turbine 327. In an exemplary embodiment, an input shaft 232 (FIG. 2) of the separator 204, 328 is coupled to, and driven by, an accessory gearbox 142. In other exemplary embodiments, the input shaft 232 may be mechanically coupled to any other suitable power source, such as an electric, hydraulic, pneumatic, or other power source that is separate from the turbine 327.

It will be appreciated, however, that in other exemplary embodiments, the fuel oxygen reduction unit 312 may have any other suitable configuration. For example, in other embodiments, the fuel oxygen reduction unit 312 may have any other suitable separator 328, may have its components arranged in any other suitable flow order, may not include each of the components depicted, may include components configured in any other suitable manner, or may include other components not depicted or described herein.

Referring still to the embodiment of FIG. 6, as with the exemplary separator 204 described above with reference to FIGS. 2 and 5, the separator 328 depicted in FIG. 6 is further configured to generate a pressure rise in the fuel flow of least about sixty (60) psi, such as at least ninety (90) psi and up to about seven hundred and fifty (750) psi. In such a manner, a liquid fuel outlet pressure generated by the separator 328 may be at least about seventy (70) psi, or greater. Such may be accomplished in certain exemplary embodiments through a single stage separator/pump assembly (see, e.g., assembly 234 of FIG. 5).

With such an increase in pressure in the outlet fuel flow through the separator 328 of the fuel oxygen reduction unit 312, the separator 328 of the fuel oxygen reduction unit 312 depicted may provide substantially all of a necessary pressure rise of the fuel flow within the fuel delivery system 300 downstream of the draw pump 304 and upstream of the main fuel pump 308. Such is the case with the exemplary fuel delivery system 300 depicted in FIG. 6. Accordingly, for the exemplary embodiment depicted, the separator 328 of the fuel oxygen reduction unit 312 effectively obviates a need for including a separate booster pump for the fuel flow through the fuel delivery system 300 downstream of the draw pump 304 and upstream of the main fuel pump 308. Such may reduce a cost and weight of the fuel delivery system 300.

In such a manner, it will further be appreciated that for the embodiment shown in FIG. 6, substantially all of the fuel flow from the draw pump 304 to the main fuel pump 308 flows through the separator 328 of the fuel oxygen reduction unit 312. More specifically, for the exemplary embodiment depicted, substantially all of the fuel flow from the draw pump 304 to the main fuel pump 308 flows through the separator 328 of the fuel oxygen reduction unit 312 without option for bypass (i.e., no bypass lines around the separator 328 for the embodiment shown). Such may therefore ensure that the separator 328 of the fuel oxygen reduction unit 312 may provide a desired amount of pressure rise in the fuel flow between the draw pump 304 and the main fuel pump 308. Note, however, that in other exemplary aspects of the present disclosure, the fuel delivery system 300 may include one or more bypass lines and/or a fuel booster pump. However, with the inclusion of the separator 328, a size of any such fuel booster pump may not need to be as great.

From the fuel oxygen reduction unit 312, the flow of outlet fuel is provided to a third fuel line 332 of the fuel delivery system 300. The third fuel line 332 of the fuel delivery system 300 is in fluid communication with one or more engine system heat exchangers, each engine system heat exchanger thermally coupling the third fuel line 332 (or rather a fuel flow through the third fuel line 332) to a respective engine system. More specifically, for the embodiment shown, the third fuel line 332 is in thermal communication with a first engine system heat exchanger 334 and a second engine system heat exchanger 336. The first engine system heat exchanger 334 and second engine system heat exchanger 336 may be thermally coupled to a respective first engine system 338 and second engine system 340. The first and second engine systems 338, 340 may be any suitable engine system, such as one or more of a main lubrication oil system, a variable frequency generator system, etc.

The third fuel line 332 further extends to the main fuel pump 308, such that the aforementioned one or heat exchangers 334, 336 are positioned upstream of the main fuel pump 308 and downstream of the fuel oxygen reduction unit 312. The main fuel pump 308 may further increase a pressure of the fuel flow from the third fuel line 332 and provide such relatively high pressure fuel flow through a fourth fuel line 342 of the fuel delivery system 300. Notably, the exemplary fuel delivery system 300 further includes a fuel metering unit 344 and a fifth fuel line 346. For the embodiment depicted, the fourth fuel line 342 extends to the fuel metering unit 344 of the fuel delivery system 300. The exemplary fuel metering unit 344 generally includes a fuel metering valve 348 and a bypass valve 350. The fuel metering valve 348 is positioned downstream the bypass valve 350 for the embodiment shown, but these positions may be reversed. The fuel metering valve 348 may be configured to meter a fuel flow provided to and through the fifth fuel line 346 to, e.g., a combustion device. More specifically, for the embodiment depicted, the fifth fuel line 346 is configured to provide fuel flow to one or more combustor assemblies 352 (which may be, e.g., within a combustion section of a gas turbine engine; see, e.g., FIG. 1). In such a manner, the fuel metering valve 348 may control operations of, e.g., a gas turbine engine including the one or more combustion assemblies 352 by modulating a fuel flow to such combustor assemblies 352. Accordingly, it will be appreciated that the bypass valve 350 of the fuel metering unit 344 may return fuel flow to a location upstream of the fuel metering unit 344 when such fuel is not required or desired by the combustion device (as dictated by the fuel metering valve 348). Specifically, for the embodiment shown, the bypass valve 350 is configured to return such fuel through a sixth fuel line 354 of fuel delivery system 300 to a juncture 356 in the third fuel line 332 upstream of the one or heat exchangers (i.e., heat exchangers 334, 336 for the embodiment depicted).

Briefly, it will also be appreciated that for the embodiment shown, the fuel delivery system 300 includes a third heat exchanger 358 positioned downstream of the fuel metering unit 344 and upstream of the combustor assemblies 352. The third heat exchanger 358 may also be an engine system heat exchanger configured to thermally connected the fuel flow through the fifth fuel line 346 to such engine system (i.e., a third engine system 360). The third engine system 360 thermally coupled to the third heat exchanger 358 may be the same as one of the engine systems 338, 340 described above, or alternatively, may be any other suitable engine system.

In such a manner, it will be appreciated that inclusion of the fuel oxygen reduction unit 312 having a separator 328 as described herein and positioned in the manner described herein may allow for more efficient fuel delivery system 300. For example, providing the fuel oxygen reduction unit 312 downstream of the draw pump 304 and upstream of the main fuel pump 308, heat may be added to the deoxygenated fuel upstream of the main fuel pump 308 (as well as downstream of the main fuel pump 308). Further, inclusion of a separator 328 in accordance with an embodiment described herein may allow for a reduction in size of a boost pump, or an elimination of such a boost pump (such as in the embodiment depicted), potentially saving costs and weight of the fuel delivery system 300.

In an exemplary aspect of the present disclosure, a method is provided for operating a fuel delivery system for a gas turbine engine. The method includes receiving an inlet fuel flow in an oxygen transfer assembly of a fuel oxygen reduction unit for reducing an amount of oxygen in the inlet fuel flow using a stripping gas flow through a stripping gas flowpath; operating an impeller of the fuel oxygen reduction unit at a first speed; and operating a separator of the fuel oxygen reduction unit at a second speed that is different than the first speed.

Further aspects of the invention are provided by the subject matter of the following clauses:

1. A fuel delivery system for a gas turbine engine comprising: a fuel oxygen reduction unit defining a liquid fuel flowpath and a stripping gas flowpath and configured to transfer an oxygen content of a fuel flow through the liquid fuel flowpath to a stripping gas flow through the stripping gas flowpath, the fuel oxygen conversion unit comprising: an impeller in airflow communication with the stripping gas flowpath for circulating the stripping gas flow through the stripping gas flowpath; and a turbine coupled to the impeller.

2. The fuel delivery system of any preceding clause, wherein the turbine is powered by a bleed air through a bleed air conduit, and wherein the stripping gas flowpath of the fuel oxygen reduction unit is in airflow communication with the bleed air conduit.

3. The fuel delivery system of any preceding clause, wherein the turbine is powered by a bleed air, and the impeller is coupled to, and driven by, the turbine.

4. The fuel delivery system of any preceding clause, wherein the turbine is powered by a main engine bleed air.

5. The fuel delivery system of any preceding clause, further comprising a first valve downstream of the turbine, wherein the first valve modulates the main engine bleed air downstream of the turbine to control a speed of rotation of the impeller.

6. The fuel delivery system of any preceding clause, further comprising a second valve upstream of the turbine, wherein the second valve modulates the main engine bleed air upstream of the turbine to control the speed of rotation of the impeller.

7. The fuel delivery system of any preceding clause, wherein the fuel oxygen conversion unit comprises: a contactor including a fuel inlet that receives the fuel flow from the liquid fuel flowpath and a stripping gas inlet that receives the stripping gas flow from the stripping gas flowpath, the contactor configured to form a fuel/gas mixture; and a separator including an inlet in fluid communication with the contactor that receives the fuel/gas mixture, a fuel outlet, and a stripping gas outlet, wherein the separator is configured to separate the fuel/gas mixture into an outlet stripping gas flow and an outlet fuel flow and provide the outlet stripping gas flow through the stripping gas outlet back to the stripping gas flowpath and the outlet fuel flow through the fuel outlet back to the liquid fuel flowpath.

8. The fuel delivery system of any preceding clause, wherein the separator is coupled to a second power source that is separate from the turbine.

9. The fuel delivery system of any preceding clause, further comprising a catalyst disposed downstream of the separator, the catalyst receives and treats the outlet stripping gas flow, wherein an inlet stripping gas flow exits the catalyst; wherein the impeller is disposed between the catalyst and the contactor.

10. A fuel delivery system for a gas turbine engine comprising: a fuel source; a draw pump downstream of the fuel source for generating a liquid fuel flow from the fuel source; a main fuel pump downstream of the draw pump; and a fuel oxygen reduction unit downstream of the draw pump and upstream of the main fuel pump, the fuel oxygen reduction unit comprising: a stripping gas line; a contactor in fluid communication with the stripping gas line and the draw pump for forming a fuel/gas mixture, wherein the contactor receives an inlet fuel flow from the draw pump; a separator in fluid communication with the contactor, the separator receives the fuel/gas mixture and separates the fuel/gas mixture into an outlet stripping gas flow and an outlet fuel flow at a location upstream of the main fuel pump; an impeller disposed downstream of the separator and upstream of the contactor, wherein the impeller circulates a stripping gas to the contactor; and a turbine coupled to the impeller.

11. The fuel delivery system of any preceding clause, wherein the turbine is powered by a bleed air, and the impeller is coupled to, and driven by, the turbine.

12. The fuel delivery system of any preceding clause, wherein the turbine is powered by a main engine bleed air.

13. The fuel delivery system of any preceding clause, further comprising a first valve downstream of the turbine, wherein the first valve modulates the main engine bleed air downstream of the turbine to control a speed of rotation of the impeller.

14. The fuel delivery system of any preceding clause, further comprising a second valve upstream of the turbine, wherein the second valve modulates the main engine bleed air upstream of the turbine to control the speed of rotation of the impeller.

15. The fuel delivery system of any preceding clause, wherein the separator is coupled to a second power source that is separate from the turbine.

16. The fuel delivery system of any preceding clause, wherein an input shaft of the separator is coupled to, and driven by, an accessory gearbox.

17. The fuel delivery system of any preceding clause, further comprising a catalyst disposed downstream of the separator, the catalyst receives and treats the outlet stripping gas flow, wherein an inlet stripping gas flow exits the catalyst; wherein the impeller is disposed between the catalyst and the contactor.

18. The fuel delivery system of any preceding clause, wherein the turbine comprises a bleed gas recovery turbine.

19. The fuel delivery system of any preceding clause, wherein the main engine bleed air comprises a high pressure compressor bleed air, and wherein the fuel oxygen reduction unit recirculates the high pressure compressor bleed air back to a high pressure compressor of a main engine.

20. The fuel delivery system of any preceding clause, wherein the outlet fuel flow has a lower oxygen content than the inlet fuel flow, and wherein the outlet stripping gas flow has a higher oxygen content than the inlet stripping gas flow.

21. The fuel oxygen reduction unit of any preceding clause, wherein the gas boost pump is electrically coupled to a permanent magnet alternator (PMA).

22. The fuel oxygen reduction unit of any preceding clause, wherein the separator is electrically coupled to a permanent magnet alternator (PMA).

23. The fuel oxygen reduction unit of any preceding clause, wherein the fuel oxygen reduction unit further includes a fuel oxygen sensor.

24. The fuel oxygen reduction unit of any preceding clause, wherein the fuel oxygen reduction unit further includes a gas oxygen sensor.

25. The fuel oxygen reduction unit of any preceding clause, wherein the fuel oxygen reduction unit further includes a speed sensor.

26. The fuel oxygen reduction unit of any preceding clause, wherein the fuel oxygen reduction unit further includes a gas bypass loop.

27. A method is provided for operating a fuel delivery system for a gas turbine engine. The method includes receiving an inlet fuel flow in an oxygen transfer assembly of a fuel oxygen reduction unit for reducing an amount of oxygen in the inlet fuel flow using a stripping gas flow through a stripping gas flowpath; operating an impeller of the fuel oxygen reduction unit at a first speed; and operating a separator of the fuel oxygen reduction unit at a second speed that is different than the first speed.

28. A method for operating a fuel delivery system comprising: using a fuel oxygen reduction unit to reduce an oxygen content of a fuel flow through the fuel delivery system, wherein using the fuel oxygen reduction unit comprises operating a gas pump in fluid communication with a stripping gas flowpath of the fuel oxygen reduction unit at a first speed; and operating a separator in fluid communication with the stripping gas flowpath of the fuel oxygen reduction unit and a fuel flowpath of the fuel delivery system at a second speed that is different than the first speed.

29. The method of any preceding clause, wherein operating the separator at the second speed that is different than the first speed comprises rotating the separator independently from the gas pump.

30. The method of any preceding clause, wherein the first speed varies relative to the second speed.

31. The method of any preceding clause, wherein operating the separator comprises driving the separator with a first power source, wherein operating the gas pump comprises driving the gas pump with a separate power source, and wherein the first power source is different than the second power source.

32. The method of any preceding clause, wherein the first power source is an accessory gearbox, and wherein the second power source is a turbine in fluid communication with a fluid flow.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A fuel delivery system for a gas turbine engine comprising:
a fuel oxygen reduction unit defining a liquid fuel flowpath and a stripping gas flowpath and configured to transfer an oxygen content of a fuel flow through the liquid fuel flowpath to a stripping gas flow through the stripping gas flowpath, the fuel oxygen conversion unit comprising:
an impeller in airflow communication with the stripping gas flowpath for circulating the stripping gas flow through the stripping gas flowpath; and
a turbine coupled to the impeller.

2. The fuel delivery system of claim 1, wherein the turbine is powered by a bleed air through a bleed air conduit, and wherein the stripping gas flowpath of the fuel oxygen reduction unit is in airflow communication with the bleed air conduit.

3. The fuel delivery system of claim 1, wherein the turbine is powered by a bleed air, and wherein the impeller is coupled to, and driven by, the turbine.

4. The fuel delivery system of claim 3, wherein the turbine is powered by a main engine bleed air.

5. The fuel delivery system of claim 4, further comprising:
a first valve downstream of the turbine,
wherein the first valve modulates the main engine bleed air downstream of the turbine to control a speed of rotation of the impeller.

6. The fuel delivery system of claim 5, further comprising:
a second valve upstream of the turbine,
wherein the second valve modulates the main engine bleed air upstream of the turbine to control the speed of rotation of the impeller.

7. The fuel delivery system of claim 1, wherein the fuel oxygen conversion unit comprises:
a contactor including a fuel inlet that receives the fuel flow from the liquid fuel flowpath and a stripping gas inlet that receives the stripping gas flow from the stripping gas flowpath, the contactor configured to form a fuel/gas mixture; and
a separator including an inlet in fluid communication with the contactor that receives the fuel/gas mixture, a fuel outlet, and a stripping gas outlet, wherein the separator is configured to separate the fuel/gas mixture into an outlet stripping gas flow and an outlet fuel flow and provide the outlet stripping gas flow through the stripping gas outlet back to the stripping gas flowpath and the outlet fuel flow through the fuel outlet back to the liquid fuel flowpath.

8. The fuel delivery system of claim 7, wherein the separator is coupled to a second power source that is separate from the turbine.

9. The fuel delivery system of claim 7, further comprising:
a catalyst disposed downstream of the separator, the catalyst receives and treats the outlet stripping gas flow, wherein an inlet stripping gas flow exits the catalyst;
wherein the impeller is disposed between the catalyst and the contactor.

10. A fuel delivery system for a gas turbine engine comprising:
a fuel source;
a draw pump downstream of the fuel source for generating a liquid fuel flow from the fuel source;
a main fuel pump downstream of the draw pump; and
a fuel oxygen reduction unit downstream of the draw pump and upstream of the main fuel pump, the fuel oxygen reduction unit comprising:
a stripping gas line;
a contactor in fluid communication with the stripping gas line and the draw pump for forming a fuel/gas mixture, wherein the contactor receives an inlet fuel flow from the draw pump;
a separator in fluid communication with the contactor, the separator receives the fuel/gas mixture and separates the fuel/gas mixture into an outlet stripping gas flow and an outlet fuel flow at a location upstream of the main fuel pump;
an impeller disposed downstream of the separator and upstream of the contactor, wherein the impeller circulates a stripping gas to the contactor; and
a turbine coupled to the impeller.

11. The fuel delivery system of claim 10, wherein the turbine is powered by a bleed air, and wherein the impeller is coupled to, and driven by, the turbine.

12. The fuel delivery system of claim 11, wherein the turbine is powered by a main engine bleed air.

13. The fuel delivery system of claim 12, further comprising:
a first valve downstream of the turbine,
wherein the first valve modulates the main engine bleed air downstream of the turbine to control a speed of rotation of the impeller.

14. The fuel delivery system of claim 13, further comprising:
a second valve upstream of the turbine,
wherein the second valve modulates the main engine bleed air upstream of the turbine to control the speed of rotation of the impeller.

15. The fuel delivery system of claim 10, wherein the separator is coupled to a second power source that is separate from the turbine.

16. The fuel delivery system of claim 15, wherein an input shaft of the separator is coupled to, and driven by, an accessory gearbox.

17. The fuel delivery system of claim 10, further comprising:
a catalyst disposed downstream of the separator, the catalyst receives and treats the outlet stripping gas flow, wherein an inlet stripping gas flow exits the catalyst;
wherein the impeller is disposed between the catalyst and the contactor.

18. The fuel delivery system of claim 11, wherein the turbine comprises a bleed gas recovery turbine.

19. The fuel delivery system of claim 12, wherein the main engine bleed air comprises a high pressure compressor bleed air, and wherein the fuel oxygen reduction unit recirculates the high pressure compressor bleed air back to a high pressure compressor of a main engine.

20. A method for operating a fuel delivery system comprising:
using a fuel oxygen reduction unit to reduce an oxygen content of a fuel flow through the fuel delivery system, wherein using the fuel oxygen reduction unit comprises
operating a gas pump in fluid communication with a stripping gas flowpath of the fuel oxygen reduction unit at a first speed; and
operating a separator in fluid communication with the stripping gas flowpath of the fuel oxygen reduction unit and a fuel flowpath of the fuel delivery system at a second speed that is different than the first speed.
